(19) United States
(12) Patent Application Publication
(10) Pub. No.: US 2020/0058047 A1
(43) Pub. Date: Feb. 20, 2020

(54) SYSTEMS FOR PERFORMING SECURE MOBILE PAYMENT AND NON-PAYMENT TRANSACTIONS WITH INTEGRATED LOYALTY, REWARDS AND PROMOTIONS

(71) Applicant: Omnyway, Inc., San Mateo, CA (US)

(72) Inventors: Mohammad Khan, San Jose, CA (US); Ashok Narasimhan, San Francisco, CA (US); William N. Melton, San Francisco, CA (US)

(21) Appl. No.: 16/661,737

(22) Filed: Oct. 23, 2019

Related U.S. Application Data
(63) Continuation of application No. 14/986,592, filed on Dec. 31, 2015, now abandoned.
(60) Provisional application No. 62/207,413, filed on Aug. 20, 2015.

(51) Int. Cl. G06Q 30/02; G06Q 20/32; G06Q 20/38; G06Q 20/20; G06Q 20/36

(52) U.S. Cl. CPC G06Q 30/0222; G06Q 20/322; G06Q 20/387; G06Q 20/202; G06Q 20/363; G06Q 20/3276; G06Q 20/3278; G06Q 30/0268; G06Q 20/3227

(57) ABSTRACT

According to one aspect, the subject matter described herein includes a system for performing secure mobile payment and non-payment transactions with integrated loyalty, rewards, and promotions. A mobile backend server (MBE) stores and maintains payment and non-payment account information for users, and presents a list of available payment and non-payment instruments to the user prior to the user's interaction with a merchant for shopping, item selection, or checkout. In response to detecting an interaction between the user and a merchant for shopping, item selection, or checkout, the MBE determines incentives that are available to the user, presents the available incentives to the user for selection prior to completion of a payment or non-payment transaction with the merchant, and determines which of the available incentives and payment instruments are selected by the user. The incentives and/or transaction amounts presented to the user are dynamically updated based on the user selection.

### PRIORITY CLAIM

The present application is a continuation of U.S. patent application Ser. No. 14/986,592, filed Dec. 31, 2015, which claims priority to U.S. Provisional Patent Application Ser. No. 62/207,413, filed on Aug. 20, 2015, the disclosures of which are incorporated herein by reference in their entireties.

### TECHNICAL FIELD

This disclosure relates to systems for performing secure mobile payment and non-payment transactions with integrated loyalty, rewards, and promotions.

### BACKGROUND

Mobile devices are increasingly used to perform financial and non-financial electronic transactions. For example, mobile devices may be used to purchase items at physical point of sale locations (e.g., “brick and mortar” stores) or over the Internet, through or within a mobile application. Conventional mobile device user interfaces that are displayed during checkout, however, have limited functionality, i.e., the user may be presented with the total and be prompted to accept or deny the transaction, and may be prompted to provide some form of authentication, such as the entry of a personal identification number (PIN).

It is common for merchants to offer promotions or discounts as a means to encourage consumers to shop with them. As used herein, the terms “merchant” and “retailer” may be used synonymously unless specifically noted otherwise. Likewise, some merchants have loyalty or rewards programs that provide incentives, such as discounts and rewards points, to customers as a means to encourage customers to shop there instead of elsewhere and to reward returning customers for their continued patronage. However, from the consumer's point of view, using or taking advantage of loyalty, rewards, or promotions is conceptually and functionally quite separate from the act of engaging in the payment or non-payment transaction.

For example, a consumer may be notified that a certain number of loyalty or rewards points has been awarded to him or her after transaction has been completed, or may not be notified at all. A consumer typically becomes aware of promotions either well before the payment transaction, such as at the point of product selection (e.g., by noticing a sign or other announcement that a certain kind of product is currently on sale) during the checkout process (e.g., while the item is being rung up at the cash register the discounted price is displayed) or after the transaction is complete (e.g., the client is told how much money was saved due to using a loyalty card) but such information is never presented to the consumer in a manner that allows the consumer the opportunity to make a decision, such as selection of a loyalty, reward, or promotion, prior to completion of the transaction and/or as an aid to deciding how the transaction will be effected, especially when the consumer has multiple options regarding choice of payment instrument, choice of loyalty program, etc.

In conventional systems, the merchant is likewise unaware of how, exactly, the consumer intends to complete the transaction until the moment that payment is initiated, i.e., at the conclusion of the transaction. For example, a shopper at a grocery store may present a loyalty or rewards card to the cashier at some point during the checkout process, but the merchant does not know whether the purchaser intends to pay with cash, credit, or debit until the end of the checkout process, when the customer makes the payment. Moreover, even if a merchant knows that a customer is paying by credit card, the merchant may not know which brand of card, or which bank issued the card, and so on. Thus, the merchant is likewise not given the opportunity to offer the customer enticements in the form of loyalty or rewards points, promotions, and the like, prior to completion of the transaction and/or as an aid to helping the customer decide how to effect the transaction, especially when the consumer has multiple options regarding choice of payment instrument, choice of loyalty program, and so forth.

As such, there is a need for providing merchants with the opportunity to provide loyalty, rewards, promotions, or other enticements to the consumer, and for providing consumers with the opportunity to make decisions based on such enticements, prior to making the payment or otherwise concluding the transaction, when such transactions are made using a mobile device. There is a need to provide electronic transaction systems that allow a merchant and a consumer to engage in a high degree of interaction prior to conclusion of the transaction. In short, there is a need for systems for performing secure mobile payment and non-payment transactions with integrated loyalty, rewards, and promotions.

### SUMMARY

The subject matter disclosed herein includes systems for performing secure mobile payment and non-payment transactions with integrated loyalty, rewards, and promotions.

According to one aspect, the subject matter described herein includes a system for performing secure mobile payment and non-payment transactions with integrated loyalty, rewards, and promotions. The system includes a mobile backend server that stores and maintains payment and non-payment account information for users; that presents a list of available payment and non-payment instruments to the user prior to the user's interaction with a merchant for shopping, item selection, or checkout, and that detects an interaction between the user and a merchant for shopping, item selection, or checkout. In response to that detection, the mobile backend server determines incentives that are available to the user, including loyalty points, rewards, discounts, coupons (including item-specific coupons), and/or promotions, and presents the available incentives to the user for selection prior to completion of a payment or non-payment transaction with the merchant. The mobile backend server determines which of the available incentives are selected by the user. The incentives and/or transaction amounts presented to the user are dynamically updated based on an incentive and/or payment instrument selection by the user prior to completion of the transaction.

As used herein, the term “incentive” refers to loyalty points, rewards, discounts, or promotions. As used herein, the term “promotion” refers to coupons, offers, advertising, marketing materials, free or complementary items, or other tangible or intangible items provided by the merchant, the manufacturers, or any other third party to promote a sale of products or services associated with the promotion.

The subject matter described herein may be implemented in hardware, software, firmware, or any combination thereof. As such, the terms “function” or “module” as used herein refer to hardware, software, and/or firmware for implementing the feature being described.

In one exemplary implementation, the subject matter described herein may be implemented using a computer readable medium having stored thereon executable instructions that when executed by the processor of a computer control the computer to perform steps. Exemplary computer readable media suitable for implementing the subject matter described herein include disk memory devices, chip memory devices, programmable logic devices, application specific integrated circuits, and other non-transitory storage media. In one implementation, the computer readable medium may include a memory accessible by a processor of a computer or other like device. The memory may include instructions executable by the processor for implementing any of the methods described herein. In addition, a computer readable medium that implements the subject matter described herein may be located on a single device or computing platform or may be distributed across multiple physical devices and/or computing platforms.

As used herein, the term “user” refers to someone who uses a payment card or other payment instrument associated with an account to perform a transaction, whether or not they have the ability or permission level to control behaviors and capabilities of the entity's accounts and/or account transactions.

As used herein, the term “privileged user” refers to a user who can control behaviors and capabilities of the entity's accounts and/or account transactions for themselves but not for other users, and whose settings can be overridden by an administrator. For example, a privileged user may set, modify, or delete limits, rules, and behaviors (collectively referred to as “rules”) that apply only to himself or herself.

As used herein, the term “administrator” (or “admin” for short) refers to someone who can control behaviors and capabilities of the entity's accounts and/or account transactions on a per-user basis. For example, an admin may set, modify, or delete limits, rules, and behaviors (collectively referred to as “rules”.) According to one aspect, a “limited admin” can set rules for other users of the same or lower permission level, and a “full admin” (or just “admin”) can set rules for any and all users regardless of the users' permission level. A full admin may supplement or override settings by a limited admin. An administrator may or may not be a user. For example, a business entity may have an admin who sets rules but who never actually uses the company card.

As used herein, the term “owner” refers to a person or business entity whose name is on the card/account. The owner may or may not be an administrator and may or may not be a user. For example, for a personal card, the owner is probably the same as the administrator and is probably also a user. For a corporate account, however, the owner may be the corporate entity (and may not be a user) while the administrator may be the CFO or other individual.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

Embodiments of the subject matter described herein will now be explained with reference to the accompanying drawings, wherein the like reference numerals represent like parts, of which:

FIG. 1 is a block diagram illustrating an exemplary a system for performing secure mobile payment and non-payment transactions with integrated loyalty, rewards, and promotions according to an embodiment of the subject matter described herein;

FIG. 2 illustrates exemplary processes for performing secure mobile payment and non-payment transactions with integrated loyalty, rewards, and promotions according to an embodiment of the subject matter herein;

FIGS. 3A, 3B, 3C, 3D, 3E, 3F, and 3G are simulated screenshots of an exemplary user interface for performing secure mobile payment and non-payment transactions with integrated loyalty, rewards, and promotions according to embodiments of the subject matter described herein; and

FIGS. 4A, 4B, and 4C illustrate an exemplary process for performing secure mobile payment and non-payment transactions with integrated loyalty, rewards, and promotions according to an embodiment of the subject matter herein.

### DETAILED DESCRIPTION

Systems for performing secure mobile payment and non-payment transactions with integrated loyalty, rewards, and promotions are provided herein.

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It should be understood that, although the terms first, second, etc. may be used herein to describe various elements, these elements should not be limited by these terms. These terms are only used to distinguish between elements. For example, a first element could be termed a second element, and, similarly, a second element could be termed a first element, without departing from the scope of the present disclosure.

It should also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It should also be understood that the singular forms “a,” “an,” and “the” include the plural forms, unless the context clearly indicates otherwise. The terms “comprises,” “comprising,” “includes,” and/or “including,” when used herein specify the presence of stated features, integers, steps, operations, elements, and/or components, but do not preclude the presence or addition of one or more other features, integers, steps, operations, elements, components, and/or groups thereof. Moreover, the term “and/or” includes any and all combinations of one or more of the associated listed items.

Unless otherwise defined, all terms (including technical and scientific terms) used herein have the same meaning as commonly understood by one of ordinary skill in the art to which this disclosure belongs. It will be further understood that terms used herein should be interpreted as having meanings that are consistent with their meanings in the context of this specification and the relevant art and will not be interpreted in an idealized or overly formal sense unless expressly so defined herein.

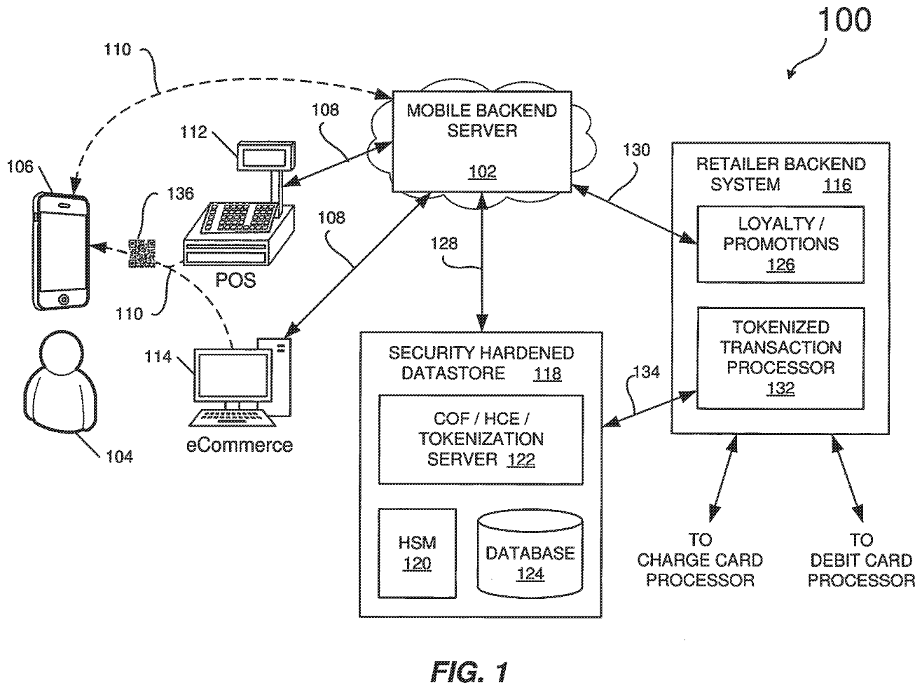

FIG. 1 is a block diagram illustrating an exemplary system 100 for performing secure mobile payment and non-payment transactions with integrated loyalty, rewards, and promotions according to an embodiment of the subject matter described herein. System 100 and other embodiments described herein provide an infrastructure with which a merchant and a customer may engage in an interactive, pre-payment process in which the merchant can provide the customer with information about loyalty, rewards, and promotions, which the customer can use to make decisions about what products to purchase, what loyalty cards to use, what payment instruments to use, etc., prior to the payment step (e.g., before “swiping the card”.)

In the embodiment illustrated in FIG. 1, system 100 includes a mobile backend (MBE) server 102, which stores and maintains private information, including sensitive or confidential information, of a user 104 of a mobile device 106 and that can provide that private information to a variety of entities via secure communication channels 108, which are shown in FIG. 1 as solid lines, so that the user 104 can engage in electronic transactions involving that private information without having to pass private information over insecure channels 110, which are shown in FIG. 1 as dashed lines.

In one embodiment, the mobile device 106 may be running an application that performs one or more of the following functions: optical character recognition (OCR), for identifying items, coupons, or other information; QR code scanning, where the QR code may be decoded on the mobile device 106 or at a remote server set up for that purpose; multi-factor authentication based on information provided by the user 104, including but not limited to passwords, pass codes, biometric data, etc.; connection to the MBE server 102; and enhanced, interactive checkout flow management.

In one embodiment, the MBE server 102 may perform one or more of the following functions: interfacing with the mobile application; authentication and user registration; user profile management and security; managing system work flow; HCE-tokenized transaction management; POS/ecommerce addressing and connectivity management; loyalty/promotions support; payment card behavior management; management of transaction logs/digital receipts; and assisting with merchant coupon processing.

MBE server 102 can provide private information via secure channels 108 to a variety of entities. For example, MBE server 102 may provide sensitive and confidential payment information to a point of sale (POS) terminal 112 or ecommerce website/server 114 via secure channels 108 for the purpose of performing a payment ecommerce transaction. System 100 can provide “credentials in the cloud”, which provides sensitive information via secure communication channels 108 and thus avoids transmission of credentials and other sensitive data from mobile device 106 over insecure channels 110. MBE server 102 can also interact securely with a retailer backend (RBE) system 116 to process loyalty discounts, promotions, membership-related benefits, and other functions. In one embodiment, MBE server 102 may be a component within RBE system 116.

In one embodiment, MBE server 102 uses a security hardened datastore (also referred to as “the datastore”) 118 to store critically sensitive data such as encryption keys. A hardware security module (HSM) 120, which is hardware that is hardened against attack and unauthorized access, may be used to store or encrypt/decrypt the encryption keys used by system 100. Datastore 118 may also include a card on file (COF)/host card emulation (HCE) module 122, which may operate as a tokenization server. In the embodiment illustrated in FIG. 1, datastore 118 may include one or more databases 124 or other storage means. The MBE server 102 may communicate with the datastore 118 via a secure communication channel 128. The datastore 118 may be co-located with the MBE server 102, or it may be located remotely from MBE server 102. In one embodiment, the datastore 118 may perform one or more of the following functions: tokenization generation; detokenization; “card on file” processing; providing a public key infrastructure (PKI)-encrypted channel with the mobile client; providing payment card industry data security standard (PCI-DSS).

In the embodiment illustrated in FIG. 1, the RBE system 116 includes a loyalty/promotions module 126 that maintains merchant-specific information about loyalty and promotions and that communicates with the MBE server 102 via a secure channel 130. The MBE server 102 can then communicate information about loyalty and promotions to the POS terminal 112, the ecommerce site 114, and/or directly to the user's mobile device 106. Such information can include information about promotions, information about opportunities to get loyalty or rewards points, and so on, at any time—including well before payment is initiated (e.g., before the card swipe). This allows the user 104 the opportunity to make pre-payment decisions about which products to select, which payment instrument to use, and so on, and allows the merchant the opportunity to provide incentives to the customer, well before the transaction is concluded.

In the embodiment illustrated in FIG. 1, the RBE system 116 includes a tokenized transaction processor (TTP) 132 for generating and/or redeeming tokens, which are bits of data that conceptually represent payment information but which do not actually contain any payment information. In the embodiment illustrated in FIG. 1, the TTP 132 communicates with the HCE/tokenization server 122 via a secure channel 134. In an alternative embodiment, TTP 132 may be a part of the security hardened datastore 118. The use of tokens as a substitute for actual payment information provides an additional level of security since, even if an unauthorized entity intercepts or otherwise sees the tokenized data as it travels along the communication paths within system 100, the unauthorized entity does not know what payment information that particular token is supposed to represent. In one embodiment, the RBE system 116 may perform one or more of the following functions: filtering tokenized transactions; communicating with an external de-tokenization server; translating transaction content; providing integration with a retailer switch; providing integration with processing partners; and managing retailer profiles.

The MBE server 102 can provide non-payment types of information as well. For example, the MBE server 102 can provide medical records, medication lists and prescriptions, medical symptoms and complaints, or other potentially very private patient information to a medical professional, medical facility, health care provider, or health insurance provider via a secure channel in response to a request to do so sent from mobile device 106 by the user 104. Because this information is provided from the MBE server 102 rather than from mobile device 106, the amount of data being provided can be enormous, and need not be limited by the capacity of mobile device 106 or limited by the user's data plan or other limitation imposed on the user 104 by the user's internet service provider (ISP) or cellphone provider.

System 100 leverages the benefits of several distinct types of connectivity:

Mobile to POS:

mobile device 106 can receive information directly from POS terminal 112. This information may be displayed by the POS terminal as a QR code, bar code, or other image, which mobile device 106 can scan and decode to extract the information. Mobile device 106 can also receive information through a digital connection with POS terminal 112, such as a wired or wireless connection, such as Wi-Fi, WiMAX, Bluetooth, BLE, Beacon, IR, audio file, and other means.

Mobile to Cloud:

mobile device 106 can also connect directly to the MBE server 102 for a variety of purposes, including setting up and registering the mobile device, associating the mobile device to a user, entering the user's confidential data via a secure connection, managing user-defined rules, and so on.

Cloud to POS:

the MBE server 102 provides a secure backend connection to a point of sale terminal 112, ecommerce website/server 114, etc., which is used to pass payment information or other sensitive information over a secure channel 108 rather than through mobile device 106 and an insecure or unsecured channel 110.

Cloud to Secure Data Store:

the MBE server 102 provides a secure backend connection to secure datastore 118, which can store encryption keys or other critically sensitive data.

Cloud to Merchant Backend Server:

the MBE server 102 provides a secure backend connection to a RBE system 116, which may provide information about a payment or non-payment transaction, loyalty programs, promotions, member discounts, and other features and functions that merchants desire to provide to existing and potential customers in order to encourage business.

Flexibility and Control.

The MBE server 102 can act as an intermediary or clearinghouse for all of a user's electronic transactions, which puts it in the unique position to provide centralized control of payment instruments. In one embodiment, the MBE server 102 can allow a user to define his or her own custom controls or rules to flexibly control not only the behaviors and capabilities of the user's own payment instruments or accounts but also control the payment instruments or accounts of other users, such as family members, employees of a company, or other groups of people. The MBE server 102 can support (and control) multiple payment types, multiple accounts, multiple credentials, etc., for multiple users, including on a per-group and/or per-user basis.

Examples of transaction or account information include, but are not limited to, an account name, an account number, an account issuing bank, a user name, a user physical address, a user shipping address, identification information for identifying a user, and authentication information for authenticating a user.

Examples of a transaction of the user include, but are not limited to, a payment or purchase; a credit transaction; a debit transaction; a deposit; a withdrawal; a money transfer; a transaction involving a loyalty program; a transaction involving a rewards program; or a transaction involving a diet, health, or fitness program.

Pre-Payment Activity.

In contrast to a conventional credit card, which provides identifying information to the merchant at the very end of the customer experience—i.e., when the customer has seen the total price, has agreed to pay, and swipes the card through the card reader for the purpose of completing a payment transaction that has already been defined—the MBE server 102's position as intermediary between a merchant or payment network and a customer allows it (and by extension any or all of the parties to the desired or pending transaction) to engage in novel and valuable pre-payment activity.

Dynamic, Interactive Presentation and Selection of Loyalty, Rewards, and Promotions During Shopping or Checkout.

The operation of system 100 will be described in more detail below, with reference to the embodiment illustrated in FIG. 1, but the subject matter is not limited to just this particular embodiment. For the purposes of illustration only, an interaction between the user's mobile device 106 and the POS terminal 112 will be described. In this example, the POS terminal 112 will present to the user 104 a QR code 136, which the user 104 will scan using the mobile device 106.

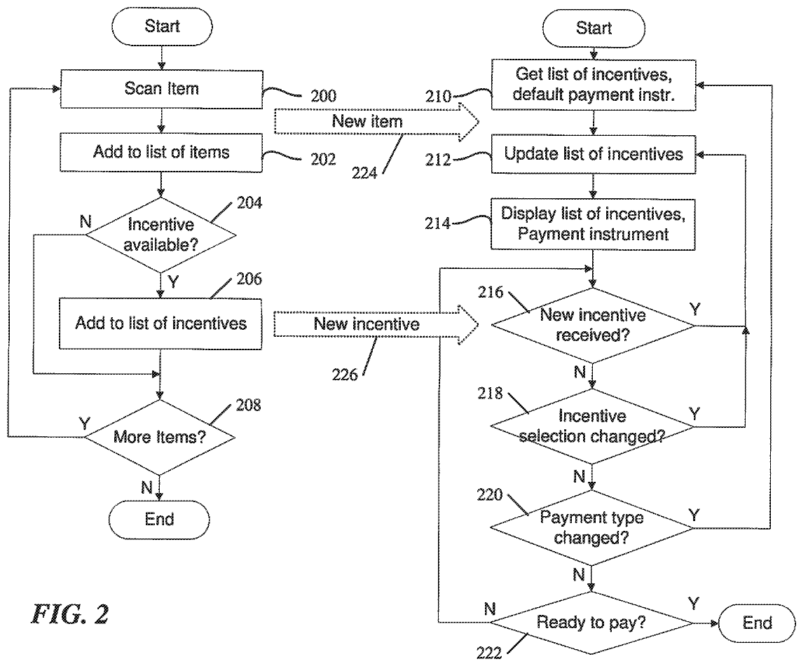

FIG. 2 illustrates exemplary processes for performing secure mobile payment and non-payment transactions with integrated loyalty, rewards, and promotions according to an embodiment of the subject matter herein. For brevity, the term “incentives” is herein used to refer to loyalty or rewards points, promotions, coupons, discounts, offers, or other benefits that may be offered to the customer by the merchant, manufacturer, or other entity. The flow chart on the left side of FIG. 2 illustrates steps that may be performed during shopping or other item selection process and/or during checkout, and which are collectively referred to as “determining incentives”. The flow chart on the right side of FIG. 2 shows actions that may be taken in response to the shopping, selection, or checkout process, and which are collectively referred to as “selecting incentives”. The steps illustrated in FIG. 2 may be performed by the mobile device 106, the POS terminal 112 or ecommerce site 114, the MBE server 102, the RBE system 116, or some combination of the above.

In the embodiment illustrated in FIG. 2, the process of determining incentives starts when an item is scanned (block 200). The item may be scanned during the process of checking out, e.g., by a POS terminal 112, or prior to checkout, such as while the user is browsing a physical store, e.g., by scanning a barcode, SKU identifier, or other product identifier using his or her mobile phone 106. In one embodiment, the scanned item is added to a list of items (block 202). If an incentive related to that item is available (block 204), it is added to a running list of incentives (block 206). The process ends when there are no more items (block 208) or other trigger condition.

In the embodiment illustrated in FIG. 2, the process of selecting incentives includes getting the list of incentives, and, optionally, the default payment instrument (block 210), updating that list if needed (block 212), and displaying or otherwise presenting that list of available incentives, and, optionally, the current payment instrument, to the user (block 214). In one embodiment, the user's mobile device 106 will dynamically display to the user 104 incentives that are available. The incentives may be displayed item-by-item, e.g., when a new item is scanned, any available coupons, offers, or other incentives may be added to a list of incentives being displayed to the user 104 via the mobile device 106. When a new incentive is received (block 216), the list of incentives is updated (block 212). In one embodiment, the user 104 may indicate which incentives he or she wants to take advantage of (and which to not take advantage of), in which case an incentive selection may change (block 218), which may also trigger the list of incentives to be updated (block 212).

In one embodiment, the list of incentives that are available may depend upon the particular payment instrument selected for use by the user 104. In the embodiment illustrated in FIG. 2, for example, if the user 104 selects a different payment type (block 220), this may require getting the list of incentives again (block 210), which may include a completely different set of incentives. For example, a merchant may offer certain incentives exclusively to shoppers that intend to pay with a merchant-preferred credit card. Thus, the list of incentives may change depending on the payment instrument selected, depending on the loyalty program selected, depending on some other customer selection, or some combination of the above. The process of selection ends when the user 104 indicates that he or she is ready to pay or otherwise conclude the transaction (block 222).

FIG. 2 illustrates the principle that the list of incentives displayed to the user for selection may dynamically change due to events that occur prior to the actual payment step, such as during the checkout process or even before that, during the shopping process. In the embodiment illustrated in FIG. 2, using the example of a checkout process, when a new item is scanned by the POS terminal 112, notification that the particular items has been scanned may be passed to the mobile device 106, the MBE server 102, the RBE system 116, or other entity (arrow 224). This information may be used to determine whether there are any item-specific incentives available to the user, e.g., in block 210 of FIG. 2. This is especially helpful if the payment type changes, as in block 220, because the list of available incentives may depend not only on the payment type selected by the user 104 but also on the particular items scanned—e.g., some items may have discounts only if a particular payment instrument or payment type is used to complete the purchase. Thus, the “get list of incentives” step in block 210 would be more efficient if that process also maintained a list of items scanned. Alternatively, the incentive selection process may only receive notifications that a new incentive is available (arrow 226). In yet another alternative, both notifications may be sent.

In an alternative embodiment, a POS terminal 112 may simply scan an item (block 200) and provide notification of that new item (arrow 224), while the other steps of maintaining a list of items, determining available incentives, maintaining the list of available incentives, displaying the available incentives to the user, and processing the user's selection of incentives, may be handled by other entities within system 100, such as by the MBE server 102, the mobile device 106, the RBE system 116, some other entity not listed, or some combination of the above.

There are a variety of different ways in which the list of incentives may be determined. In one embodiment, the POS terminal 112 may notify the MBE server 102 whenever a new item is scanned (or after all of the items have been scanned), and the MBE server 102 may interact with the retailer backend system to determine what incentives are available for a particular user 104. The list of incentives may be provided to the user via POS terminal 112/e-commerce site 114 or via the user's mobile device 106. The particular list of incentives available to that particular user may be determined by the MBE server 102 and/or the RBE system 116. Once determined, the particular list of incentives may be sent directly or via an intermediary. For example, if the RBE system 116 determines which incentives are available for the particular user 104, the RBE system 116 may send that information to the user's mobile device 106 directly or to the MBE server 102, which forwards that information to the mobile device 106.

The dynamic and possibly iterative nature of the process illustrated in FIG. 2 illustrates the dual points that the amount of discounts or other incentives offer to the user may change based on the selected payment instrument and that the total amount that the user ultimately pays for the transaction may also change based on the particular incentives that use user chooses to take advantage of or to not take advantage of.

Ease of Use.

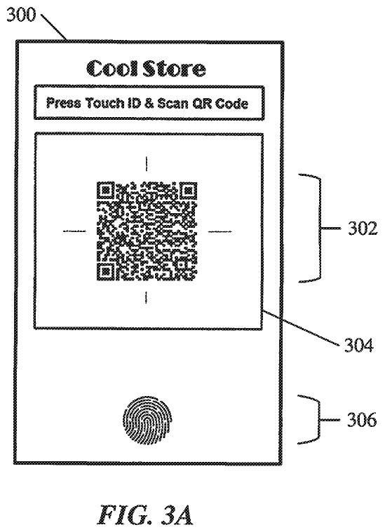

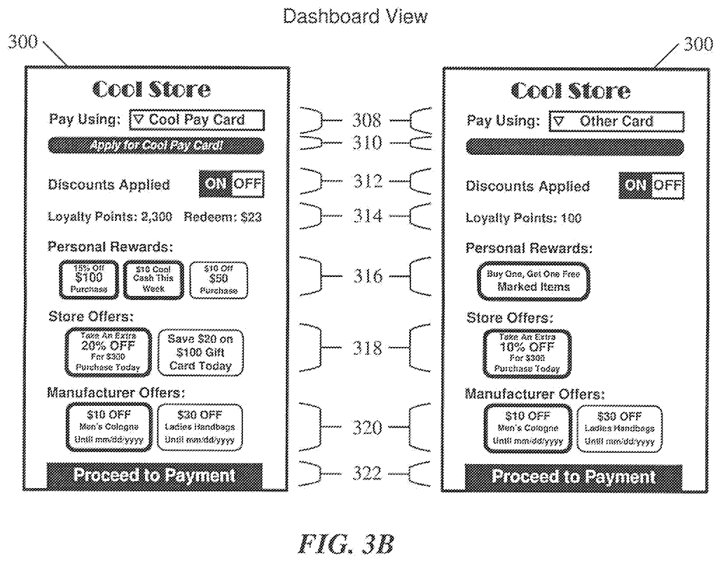

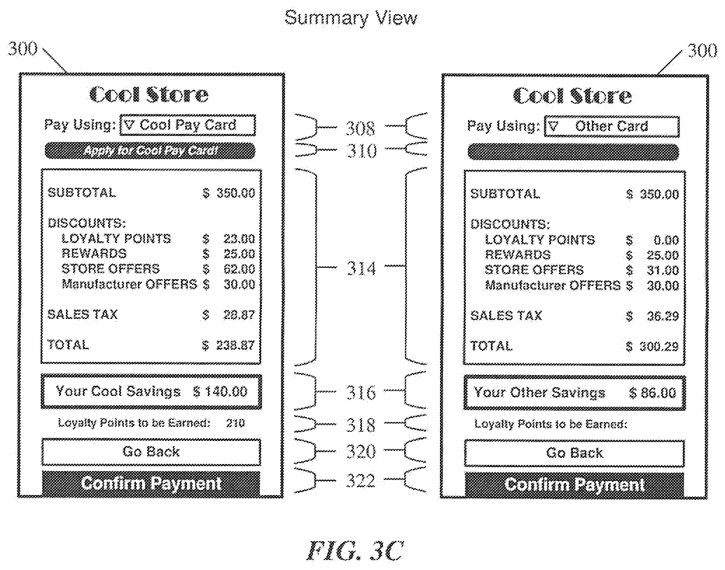

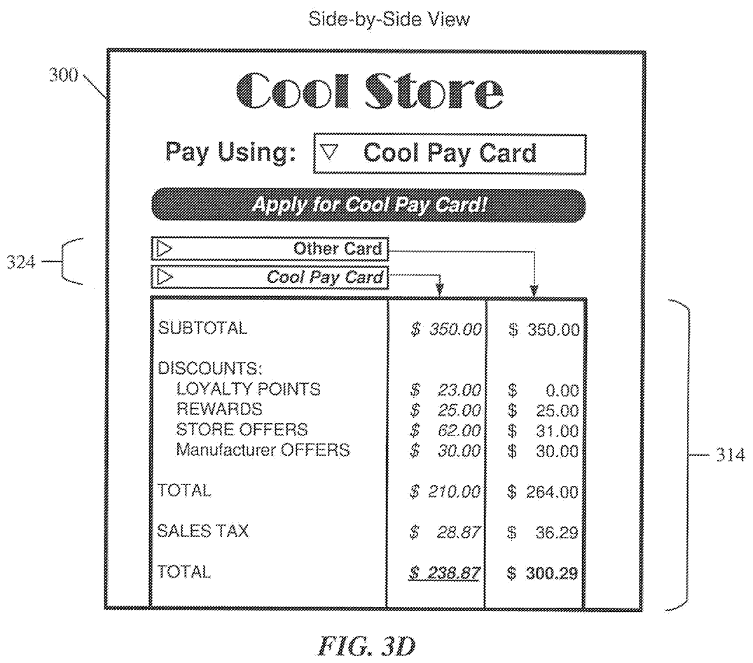

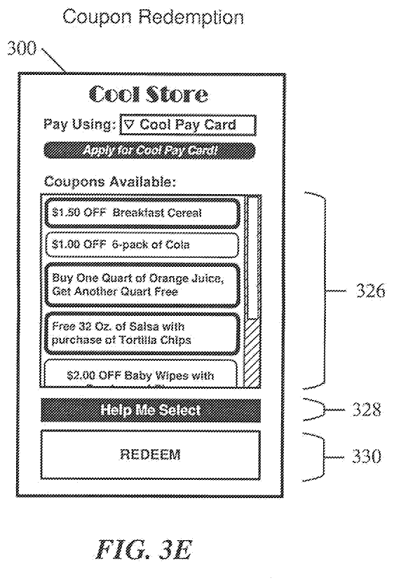

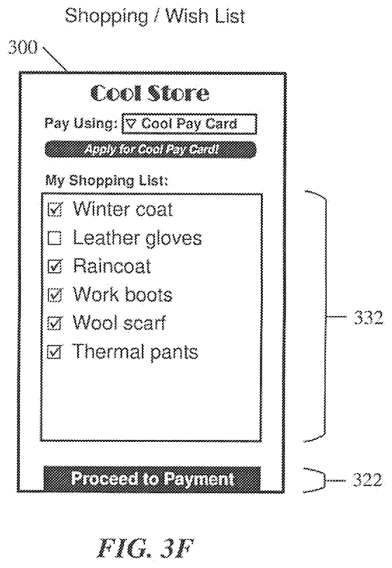

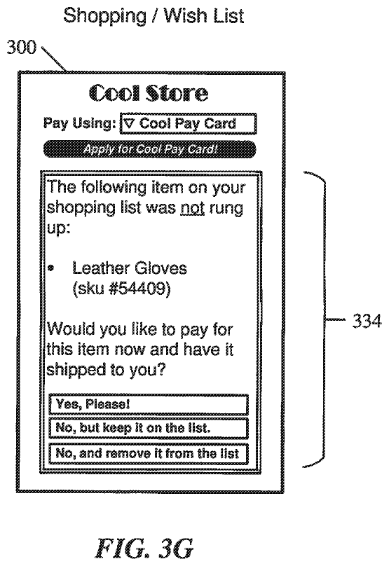

Because system 100 provides enormous flexibility, the amount of information that is presented to the user 104 may be overwhelming, especially when the user has many different options and combinations of options. Thus, in one embodiment, the user 104 is provided with a dashboard or summary of options. An example of a dashboard is shown in FIGS. 3A, 3B, and 3C.

FIGS. 3A, 3B, 3C, 3D, 3E, 3F, and 3G are simulated screenshots of an exemplary user interface for performing secure mobile payment and non-payment transactions with integrated loyalty, rewards, and promotions according to embodiments of the subject matter described herein.

FIG. 3A illustrates an example user interface (UI) 300 according to an embodiment of the subject matter described herein, which may be presented to the user 104 via his or her mobile device 106 and/or by ecommerce site 114. In this example, the UI 300 presents to the user 104 a QR code 302, which may be scanned or otherwise acquired by the mobile device 106. In embodiments where the QR code 302 is presented by an entity other than the mobile device 106, such as by the POS terminal 112, UI 300 may include a target window 304 for centering the external QR code image in the proper location to be captured by the mobile device's onboard camera. In embodiments where the mobile device 106 is being used to browse an ecommerce site 114, for example, the web page being displayed by the ecommerce site 114 may include the QR code 302 as a graphic element, in which the browser or mobile application that the user 104 is using may include the ability to detect and capture the embedded QR image. Information may be conveyed to the mobile device 106 via other mechanisms as well, including via wireless communication, such as Wi-Fi, Bluetooth, and near field communication (NFC), via wired communication, via removable memory device, via manual entry, via scanning other visual images like barcodes, text, etc., and via audio files, which are received or recorded by the mobile device 106.

In the embodiment illustrated in FIG. 3A, the UI 300 also includes an optional fingerprint sensor 306, which may be used to authenticate the user of the mobile device. In alternative embodiments, the UI 300 may provide other interface elements for the purpose of user authentication, such place for the user to enter a password, passcode, or pin, a button by which the user may initiate a facial recognition or voice recognition function, and so on. The UI 300 may implement other forms of authentication, including, but not limited to, authentication of date, time, and/or location of the user 104 or the mobile device 106.

FIG. 3B illustrates how the UI 300 may display to the user 104 a “dashboard” view of the options currently available for selection by the user 104 according to an embodiment of the subject matter described herein, and how those options might change based on the payment instrument selected. In the embodiment illustrated in FIG. 3B, for example, UI 300 displays a payment instrument selection button 308, by which the user can select or change the manner of payment, e.g., credit card, debit card, cash, etc., as well as the particular instrument used, e.g., a merchant-branded card, a club membership card, and the like. FIG. 3B shows two different scenarios: the example on the left showing how UI 300 might look if the user selects a merchant-branded or merchant-preferred card (e.g., the “Cool Pay Card”), and the example on the right showing how UI 300 might look if the user selects some other card (e.g., the “Other Card”). As can be seen in FIG. 3B and as will be described in more detail below, the loyalty points, rewards, coupons, and/or offers available to the user may differ depending on the payment instrument selected by selection button 308. The visual elements of UI 300 will now be described.

Instant Application/Registration.

In one embodiment, the UI 300 may include a button 310 that allows the user 104 to instantly apply for a merchant-branded or other type of payment or loyalty/rewards card online. By lowering the barrier to entry by eliminating or streamlining the application process, e.g., by using information about the user 104 that was collected during the initial setup of the merchant-branded mobile application, the button 310 makes it more likely that the user 104 will sign up for the merchant-branded card than if the user 104 had to fill out paperwork or an online form. In addition, the application request may be sent over the network to a retail application server which can quickly accept or deny the application, providing the user 104 with nearly instantaneous application completion, e.g., quickly enough that the user 104 can use the merchant-branded card to complete the transaction at hand. This mechanism could be used to apply for any type of card, including payment cards, merchant-branded cards, network-branded cards, private label cards, as well as non-payment cards. In one embodiment, if the user 104 already possesses a payment or loyalty/rewards card, the user 104 may use button 310 to register the card online. For example, if the mobile device 106 includes a camera, the user 104 may use the camera to scan or take a picture of the card; the mobile application will scan the image to determine identifiers such as user ID, loyalty ID, merchant ID, account numbers, etc., and use that information to register the card and associate it with the particular user 104.

In one embodiment, the user 104 may be notified that he or she may qualify for additional benefits simply by signing up—i.e., unrelated to subsequent payment or non-payment transactions using the card—such as earning points or rewards for signing up or for transferring an existing balance, for example.

Speculative/Potential Benefits.

A very powerful yet easily overlooked beneficial aspect of the embodiments of the subject matter described herein is that the user 104 has the ability to discover what benefits there may be had from using a merchant-branded payment or loyalty/rewards card, even if that user does not have the merchant-branded card yet. The ability to see how rewards, points, offers, and coupons change based on the particular payment instrument used provides a unique opportunity for a merchant or retailer to graphically demonstrate to the user 104 how that user might benefit from the use of the merchant-branded (or merchant-preferred) payment instrument and/or loyalty or rewards program. This can provide a powerful incentive for the user to apply for the merchant-branded or merchant-preferred payment instrument or program, which can benefit both the user 104 and the merchant. In the embodiment illustrated in FIG. 3B, button 310 is active if the Cool Pay Card has been selected but inactive, disabled, and/or blank if the Other Card has been selected, e.g., because the Other Card does not have an instant application process or because the merchant only wants to provide this capability for the merchant-branded or merchant-preferred card, such as the Cool Pay Card in this example.

In the embodiment illustrated in FIG. 3B, the UI 118 includes an on/off toggle 312 allows the user 104 to enable or disable the process of determining L/R/P information and/or applying the discounts. This is useful, for example, when the user 104 is using a company-provided credit card, in which case the user 104 may not want to consume or redeem any loyalty or rewards points and/or coupons.

In the embodiment illustrated in FIG. 3B, the UI 300 includes a loyalty status line 314, which displays the user's current number of loyalty or rewards points earned (e.g., 2,300) and what dollar value they have should the user redeem them for cash or apply them towards a purchase (e.g., $23) if the user chooses to pay using the Cool Pay Card. If the user chooses the Other Card, however, the loyalty status line 314 is updated to reflect the loyalty points available to that payment instrument (e.g., 100), which in this case are not instantly redeemable, e.g., because the Other Card does not have such an arrangement with the merchant, or because the merchant wants to use the ability to instantly redeem loyalty points at the time of purchase as an incentive for customers to use that merchant's preferred payment instrument.

In one embodiment, the UI 300 may display personal rewards 316 that are available to the user 104. In the embodiment illustrated in FIG. 3B, for example, the user who has opted to pay using the Cool Pay Card has selected the option to save “15% off of a $100 purchase” and the option to win $100 in “cool cash” this week, but has not selected the “$100 off of a $302 purchase” reward option. In this embodiment, selected options are indicated by a thicker border than is displayed for unselected options, but other methods of indicating a selection are also contemplated. The user who has opted to pay using the Other Card, however, has a different set of rewards available. In the embodiment illustrated in FIG. 3B, for example, the Other Card user has only a “buy one, get one free on marked items” option.

In one embodiment, the UI 300 may display store offers 318 that are available to the user 104. In the embodiment illustrated in FIG. 3B, for example, the Cool Pay Card user has selected the option to “Take An Extra 110% Off for $300 Purchase Today” option, but has not selected the “Save $110 on $100 Gift Card Today” option. In the embodiment illustrated in FIG. 3B, the Other Card user may have the same option available, such as the “Save $110 . . . ” offer, but may also have similar, rather than same, options available, such as “Take an Extra 100% Off . . . ” instead of taking an extra 110% off, which would be available had the user chosen to pay with the Cool Pay Card instead.

In one embodiment, the UI 300 may display Manufacturer offers 320 that are available to the user 104. In the embodiment illustrated in FIG. 3B, for example, the user has selected the option to save “$120 Off Coach brand Ladies Bags” but has not selected the option to save “$100 Off Polo Men's Cologne”.

The embodiment illustrated in FIG. 3B is intended to illustrated the point that, depending on the payment instrument selected, some offers, such as the Manufacturer Offers may remain the same, other offers, such as the Store Offers, may change slightly, and still other offers, such as the Personal Rewards, may be completely different from payment instrument to payment instrument. By changing the payment instrument via selection button 308, the user can see how the loyalty, rewards, offers, coupons, and other incentives change based on what payment instrument is selected.

It should be noted that the UI 300 may be programmed so that certain sets of options are mutually exclusive and that other sets of options may be combined with each other. Likewise, the content, value, and/or terms of the rewards 316, the store offers 318, and the manufacturer offers 320 may change depending on the payment instrument selected using button 308 or other selections by the user 104. Also, other types of options not shown in FIG. 3B may be presented in addition to or instead of the set of options illustrated in FIG. 3B. The “dashboard” view provided by the UI 300 allows the user 104 to easily understand and negotiate what might otherwise be an overwhelming or confusing number of options.

In embodiments in which the MBE server 102 calculates optimal selections to assist the user 104 in choosing the set of options that provides the greatest benefit, the information displayed in the dashboard view (and in other views as well) may be initially displayed to the user with the optimum set of options already selected, e.g., pre-selected by the MBE server 102. This is a powerful feature that can further simplify the task of determining what options the user 104 should select. As the user 104 makes additional selections, or overrides the default selections, information about the selections (or information about only those selections that have changed) may be sent to the MBE server 102, in which case the optimization step may again be performed. In one embodiment, the user 104 may have the ability to enable, disable, or otherwise control or manage this automatic optimization process.

In the embodiment illustrated in FIG. 3B, the UI 300 includes a Proceed to Payment button 322, by which the user 104 may indicate that he or she has completed the selection process and is now ready to proceed to payment or otherwise complete the transaction.

It should be noted that the options made available to the user 104 may change or be presented to the user 104 on an item-by-item basis during the shopping and/or checkout process. In one embodiment, for example, the mobile device 106 dynamically interacts with the RBE system 116, either directly or through MBE server 102, during the checkout process. As each item is scanned during checkout, the user 104 may be presented with item-specific loyalty or rewards options, promotions, store or merchant coupons, etc. In one embodiment, the scanning operation at the POS terminal 112 provides item information to the RBE system 116; the RBE system 116 determines what L/R/P options are available to the user 104, and sends them to the MBE server 102 or the mobile device 106; the user 104 is then provided with a list of choices and options; the user 104 may then use the UI 300 on mobile device 106 to go through the list item by item and choose what promotions, etc., to accept and which ones to decline.

FIG. 3C illustrates how the UI 300 may display to the user 104 a summary view of the transaction as it will be executed using the user's selections, before the transaction is actually initiated, according to an embodiment of the subject matter described herein, and how those totals might change based on the payment instrument selected. FIG. 3C shows two different scenarios: the example on the left showing how UI 300 might look if the user has selected a merchant-branded or merchant-preferred card (e.g., the “Cool Pay Card”), and the example on the right showing how UI 300 might look if the user has selected some other card (e.g., the “Other Card”).

In the embodiment illustrated in FIG. 3C, the UI 300 includes a summary section 314 for displaying summary information about the pending transaction, such as the subtotal before discounts, the discounts due to loyalty points, rewards, store offers, an manufacturer offers, the sales tax that will be applied, and a grand total, which is the subtotal minus discounts and plus tax.

In one embodiment, the UI 300 includes a section 316 for displaying to the user 104 a summary of the benefits that he or she will receive for having used the retailer's preferred payment method, loyalty program, and/or rewards card. This allows the retailer to highlight to the user 104 how the use of that particular retailer's branded card, for example, directly benefitted the user 104.

In one embodiment, the UI 300 includes a section 318 for indicating to the user information about the selected loyalty program, such as the current points balance or how that balance will change as a result of the pending transaction.

In one embodiment, the UI 300 includes a “go back” button 320 that allows the user 104 to change his or her selection, e.g., to choose another payment instrument, loyalty card, rewards card, and/or promotion, after which the user 104 may return to the summary page shown in FIG. 3C.

In one embodiment, the UI 300 includes a “confirm payment” button 322 that, when activated, initiates or executes the pending transaction with the user's current selections.

In the embodiment illustrated in FIG. 3C, the UI 300 also includes buttons 308 and 310, the functions of which are the same as were described with reference to FIG. 3B. In one embodiment, using the button 308 to change the payment instrument to be used will cause the contents of sections 314, 316, and 318 to be updated, and possibly changed, accordingly. In this manner, the user 104 can determine the relative benefits of selecting one payment instrument over another payment instrument, selecting one set of L/R/P options over another set of L/R/P options, or some combination of the above. In the embodiment illustrated in FIG. 3C, for example, the number of loyalty points available for redemption and the dollar amount of store offers available to the user change depending on whether the Cool Pay Card is selected (on the left) or the Other Card has been selected (on the right). As a result, the total amount that the user will ultimately pay varies significantly in this example. By changing the card selected in button 308, the user can see for himself or herself how the numbers change.

To better show a comparison of the relative benefits of selecting one payment instrument (and/or one set of L/R/P options) over another, UI 300 may include a mode that allows a side-by-side comparison of data. An example of this is shown in FIG. 3D.

FIG. 3D illustrates how UI 300 may be used to display a side-by-side comparison of payment instrument and/or L/R/P selections to the user 104 according to an embodiment of the subject matter described herein. In one embodiment, the summary section 314 may show a side-by-side comparison of the benefits of using one payment instrument over another payment instrument. In the embodiment illustrated in FIG. 3D, for example, the summary section 314 includes a column on the right for showing the discounts that are available to the user 104 if he or she uses the Other Card, and a column in the middle for showing the discounts that are available to the user 104 is he or she uses the Cool Pay Card. By using pulldown selection boxes 324, the columns can be used to display the differences between different payment instruments, loyalty/rewards cards, sets of coupons or promotions, or other comparisons selected by the user 104. FIG. 3D illustrates an example in which the user 104 can pay a substantially lower price if he or she uses the merchant-branded “Cool Pay Card” instead of the regular credit card. Likewise, in one embodiment, UI 300 may have a mode that allows the user to compare two “dashboard” views, such as shown in FIG. 3B, side by side, to see how the options change based on the user's selection of payment instrument and/or L/R/P options.

FIG. 3E illustrates how UI 300 may be used to redeem coupons, offers, and promotions according to an embodiment of the subject matter described herein. For simplicity and brevity the description will be made in terms of coupons and coupon redemption, but it will be understood that the same concepts apply also to offers, promotions, buy-one/get-one-free deals, and other incentives that may be available to the consumer.

In the embodiment illustrated in FIG. 3E, a coupon display area 326 shows coupons that are available for the user 104 to redeem. Coupon display area 326 may list coupons that the user 104 has previously collected and stored electronically in mobile device 106, and may include coupons that were sent to mobile device 106 from the RBE system 116 and/or the MBE server 102 at any time before, during, or after the shopping or checkout process. In one embodiment, during the shopping or checkout process, the mobile device 106, MBE server 102, and/or RBE system 116 may maintain a list items selected. For each item in the list, it is determined whether or not the user has or may be offered a coupon that pertains to that item, and if so, these coupons are brought to the attention of user 104, e.g., by causing them to be displayed in a list of pertinent coupons, by moving them to the top of a list of all coupons, by highlighting them in a list of all coupons, or by some other method.

In the embodiment illustrated in FIG. 3E, for example, coupon display area 326 includes a scrolling list of available coupons, some of which are selected (indicated by a thick border) and some of which are not selected (indicated by a thin border.) In one embodiment, the available coupons may be displayed but not selected until the user 104 explicitly does so. Alternatively, the available coupons may all be selected and the user 104 is expected to explicitly unselect those which he or she does not yet want to redeem or cash in.

In one embodiment, if the user 104 has multiple coupons that are mutually exclusive, RBE system 116, MBE server 102, and/or mobile device 106 may try to intelligently select the combination of coupons that best benefits the user 104. In the embodiment illustrated in FIG. 3E, for example, UI 300 includes a button 328 labeled “Help Me Select”, “Select For Me”, or similar, for invoking this function. In one embodiment, the parameters for what coupons “best benefit” the user may be defined by the user 104. Examples of benefits include, but are not limited to, paying the least total cost, getting the highest number of loyalty/rewards points, etc. In one embodiment, the user 104 may prioritize available benefits, such as indicating a desire to pay the least amount versus a desire to get the most loyalty or rewards points, etc. In one embodiment, the user 104 may override or change any automatically selected coupons.

In one embodiment, after the coupons are automatically and/or manually chosen, the user 104 may press a redeem button 330, which applies/redeems all selected coupons. In one embodiment, pressing the redeem button 328 also causes payment to automatically be initiated, using default settings, such as payment instrument and loyalty card to be used, or using settings that the user 104 previously chose or chose during the course of shopping and/or the checkout process. In this manner, the user need not press a payment button or make any other payment instruction at all.

It is noted that embodiments of the UI 300 as depicted in FIGS. 3A through 3E are illustrative and not limiting. Different information may be presented; the information presented may be presented in any arrangement, layout, or style; and the information may be presented using different types of graphic elements or controls. It is noted also that the screen or portions thereof may be scrolled horizontally or vertically to display additional elements, and that the screen or portions thereof may be resized or rotated. Selectable options may be presented using other controls; other visual or conceptual arrangements are contemplated. Some options may be mutually exclusive from each other, and likewise some options may be selected in combinations with other options, according to instructions or information provided by the RBE system 116, the MBE server 102, or other entity.

FIGS. 3F and 3G illustrate how UI 300 may be used to further enhance the user's shopping experience according to an embodiment of the subject matter described herein. In the embodiment illustrated in FIG. 3F, the user 104 may create a shopping list or wish list of items to be purchased, herein referred to as simply “the list”. The list may be stored on the mobile device 106, on the MBE server 102, on the RBE system 116, on another entity entirely, or some combination of the above. In one embodiment, the user 104 may browse a retailer's online catalog and select items to be put into their list or another person's list. When the user 104 goes to the retailer's brick-and-mortar store, the mobile device 106 activates or retrieves the list. In one embodiment, the list may be used to aid the user 104 during the shopping and item selection process, e.g., the UI 300 may include a display area 332 for displaying the list to the user 104 and for allowing the user 104 to mark items from the list as they are found and placed into a shopping basket or cart.

In one embodiment, during the checkout process, the mobile device receives information about what items are being rung up at the POS terminal 112 and determines whether an item that was rung up is on the list or not. At the conclusion of the checkout process, if an item on the list was not rung up, the user 104 may be given the opportunity to go ahead and pay for the item at the time of checkout and have the retailer ship the purchased item directly to the user's home, e.g., from a warehouse or distribution center. An example of this is shown in FIG. 3G, which includes a pop-up message 334 that asks the user 104 if he or she would like to pay for one of the items on the list and have that items shipped to him or her. In the embodiment illustrated in FIG. 3G, the user 104 is given the option to pay for the item and have it shipped, to not purchase the item now but leave it on the list, or to not purchase the item now and remove it from the list.

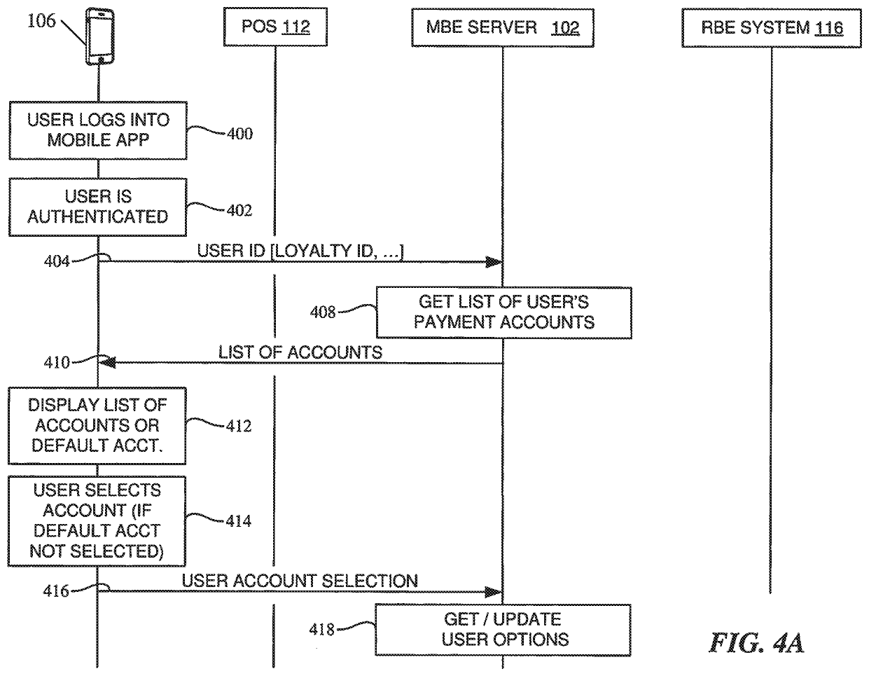

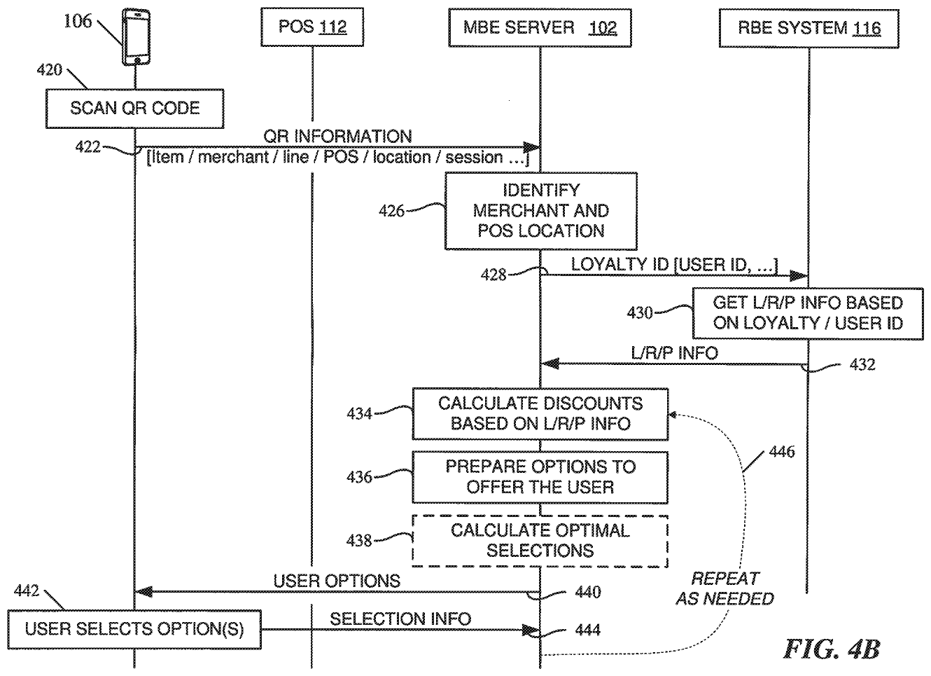

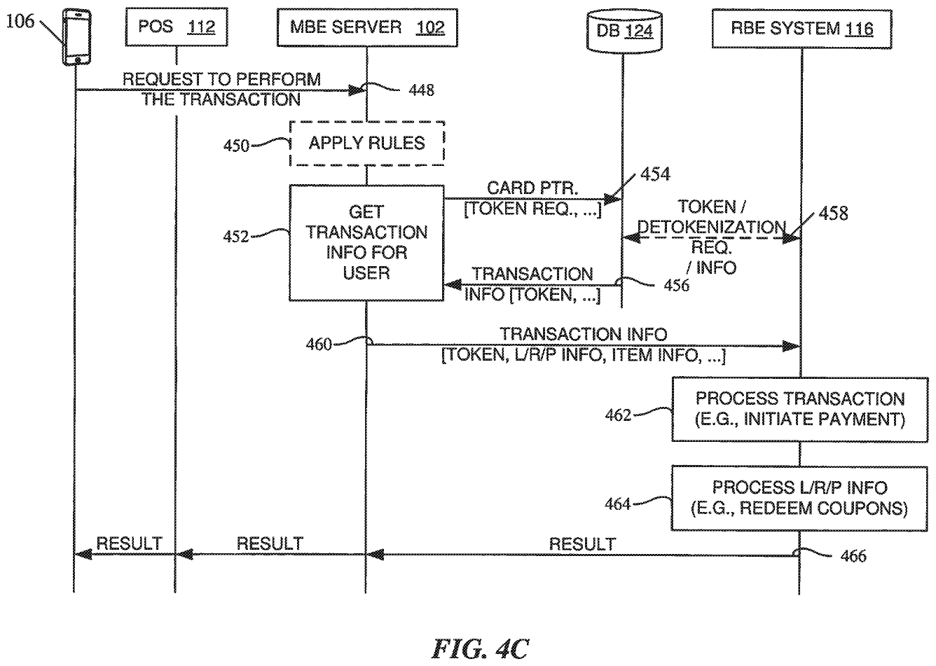

FIGS. 4A, 4B, and 4C illustrate exemplary processes for performing secure mobile payment and non-payment transactions with integrated loyalty, rewards, and promotions according to an embodiment of the subject matter herein.

FIG. 4A illustrates the steps of the process that may occur prior to shopping and/or checkout. In the embodiment illustrated in FIG. 4A, the user 104 logs into a mobile application running on the mobile device 106 (block 400). In one embodiment, the mobile application is a merchant-provided mobile application. In one embodiment, the user is authenticated (block 402). If successful, the mobile application connects with the MBE server 102 (message 404). In one embodiment, the MBE server 102 receives information that may be used to directly identify the user 104, such as a user ID, a loyalty ID, or information that may be used to indirectly identify the user 104, such as information that identifies the mobile device 106 or other information that is associated with the user 104 and can thus be used to identify the user 104.

In the embodiment illustrated in FIG. 4A, the MBE server 102 uses the information received in message 404 to get information associated with the user 104, such as a list of the user's payment accounts (block 408), which the MBE server 102 provides to the mobile device 106 (message 410). The list of accounts (or a default account, if configured) and optionally other information, is then displayed to the user 104 by the mobile device 106 (block 412). In an alternative embodiment, the mobile device 106 may maintain a list of the user's payment accounts, in which case steps 408 and 410 are not necessary and may not be performed.

In the embodiment illustrated in FIG. 4A, the user 104 may choose to select an account, whether or not a default account is selected (block 414), in which case the user's selection is conveyed to the MBE server 102 (message 416). Alternatively, one of the user's accounts may have previously been identified as a default payment account. In one embodiment, that information may be stored on the mobile device 106, in which case the notification message 416 may be sent even in the absence of an express user selection such as in block 414. In another embodiment, the MBE server 102 may store that information, in which case steps 414 and 416 need not be performed. FIG. 4A concludes with block 418, in which the MBE server 102 gets and/or updates the user's options in preparation for a transaction or other merchant interaction.

FIG. 4B illustrates the steps of the process that may occur during shopping and/or checkout. In the embodiment illustrated in FIG. 4B, the process begins when the user 104 uses his or her mobile device 106 to scan a QR code (block 420). The QR code may be presented by the POS terminal 112, in which case the data encoded within the QR code may identify the merchant, checkout line, POS terminal, location, session, etc. Alternatively, the QR code may be part of a product display, in which case the date encoded within the QR code may identify an item, a price, a discount, coupon, or other incentive, etc.

In the embodiment illustrated in FIG. 4B, the mobile device 106 decodes the QR code and sends some or all of the QR information to the MBE server 102 (message 422). The data encoded within the QR code may be encrypted, in plain text, or a combination of the two. Examples of other types of information that may be transmitted in message 422 include, but are not limited to: a name of the user 104; information that identifies the mobile device 106, which is associated with the user 104; information that identifies a loyalty or rewards account of the user; or other information that is associated with the user 104 and thus can be used to identify the user 104. Additional information may also be transmitted to MBE server 102, including, but not limited to, information that may be used to identify an item or items of interest, herein referred to as “the item information”; and other information that may be pertinent to authentication of the user, pertinent to the execution of the transaction generally, or pertinent for any other purpose.

In cases in which the user 104 is or will be making a POS transaction, the QR code may include information that identifies a particular POS terminal 112. This information is referred to herein as “the POS ID”. In implementations where each POS terminal has a unique identifier that can be mapped to particular merchant, the QR code need only include the POS ID. Other types of information that may be included in the QR code include, but are not limited to, information about the location of the POS terminal 112 and checksum data for error correction and/or fraud detection purposes.

In cases in which the user 104 is browsing the ecommerce site 114, the QR code may be presented on the website, from which it may be scanned by the mobile device 106 (e.g., when the user 104 is browsing the ecommerce site 114 on a computer separate from the mobile device 106) or detected by the mobile device 106 (e.g., when the user 104 is using the mobile device 106 to browse the ecommerce site 114.) In these embodiments, the QR code 136 may include data that identifies the ecommerce session.

In one embodiment, the mobile device 106 (e.g., the merchant's mobile application being hosted by the mobile device 106) is already provisioned to know the address of the MBE server 102. In an alternative embodiment, the address of the MBE server 102 may be determined by the mobile device 106 on an as-needed basis according to communications protocols known to one of skill in the art.

In one embodiment, the MBE server 102 may use the QR information to determine a loyalty ID for the user 104. For example, if the MBE server 102 receives the loyalty ID directly from the mobile device 106, it may simply use that information. On the other hand, if the MBE server 102 receives another form of user ID, the MBE server 102 may use the information received to query a database, such as database 124 in FIG. 1, to look up the loyalty ID.

In the embodiment illustrated in FIG. 4B, the MBE server 102 uses the QR information to identify the merchant, the transaction terminal location, and optionally other information (block 426), so that it knows which RBE system 116 with which to communicate. An example of information that identifies a merchant directly is a merchant ID, or “MID”. Once the MBE server 102 identifies the RBE system 116, it will then communicate with the RBE system 116 to determine what loyalty, rewards, and/or promotions options are available for that particular user 104. As used herein, the terms “L/R/P data” and “L/R/P information” are synonymously used to refer to the loyalty, rewards, and/or promotions data that is provided by the RBE system 116. It is noted that L/R/P data may include only loyalty data, only rewards data, only promotions data, or some combination of the three. In the embodiment illustrated in FIG. 4B, for example, the MBE server 102 sends information that identifies the particular user 104 to the RBE system 116 (message 428). The information so sent may be the loyalty ID, the user ID, or other information that the RBE system 116 may use to determine L/R/P data for the particular user 104 (block 430). This data is then provided to the MBE server 102 (message 432).

The L/R/P data is then used to determine what discounts, coupons, or other incentives may be provided to the user 104 so that he or she can make a wide variety of pre-transaction decisions, including, but not limited to, decisions about item selection, decisions about loyalty card selection or use, decisions about the accumulation or redemption of rewards points, decisions relating to retailer promotions, and decisions about payment instrument selection. Thus, in the embodiment illustrated in FIG. 4B, the MBE server 102 uses the received L/R/P information to calculate discounts and other benefits that the user 104 may select (block 434). It is noted that the step of calculating discounts may be performed by the MBE server 102, by the RBE system 116, by the mobile device 106, by the POS terminal 112, or some combination of the above. For clarity of explanation, however, this step is shown in FIG. 4B as occurring only at the MBE server 102, but the subject matter described herein is not so limited.

In the embodiment illustrated in FIG. 4B, the MBE server 102 prepares options to offer the user (block 436). For example, the L/R/P information received in message 432 may include rules or other conditions that dictate when certain incentives are to be made available to the user 104 and when they are not. Where certain incentives are available only if the user 104 intends to use a particular payment instrument, for example, the MBE server 102 may need to take these conditions and limitations into account while it prepares the options to offer the user (block 436).

In one embodiment, the MBE server 102 may optionally attempt to further simplify the potentially bewildering array of options available to the user 104 by analyze the available options and attempt to calculate the combination of options that most benefits the user 104, possibly based on parameters defined for that purpose by the user 104. Thus, in the embodiment illustrated in FIG. 4B, the MBE server 102 calculates optional selections (block 436).

In the embodiment illustrated in FIG. 4B, the user options, whether or not they have been optimized by the MBE server 102, are then sent to the mobile device 106 (message 440). The user 104 can then review the available options and make one or more selections (block 442), and the MBE server 102 is notified of the user' selection or selections, herein referred to as “the selection information” (message 444). The selection information 124 may include many kinds of information, including, but not limited to: information that identifies a payment instrument; information that identifies a loyalty card, account, or program; information that identifies a rewards card, account, or program; and information that identifies a promotion.

In one embodiment, the particular selection(s) made by the user 104 may generate additional options that the user 104 may want to consider or otherwise have an effect on the options that are then available to that user 104. Thus, in the embodiment illustrated in FIG. 4B, the process may return to block 434, iterating as many times as needed to ensure that the user 104 has the information and the opportunity to maximize his or her benefits from the loyalty, rewards, and promotions that are available to him or her. This is indicated in FIG. 4A by the dotted arrow 446, which has the label “repeat as needed”. Although not shown in FIG. 4B, in one embodiment, the iteration represented by arrow 446 may involve additional interaction between the MBE server 102 and the RBE system 116, e.g., to get additional L/R/P information based on the user's selection information. Once the user 104 is satisfied with the selection and wants to proceed to payment, the process continues on FIG. 4C.

FIG. 4C illustrates the steps of the process that may occur during the checkout process. In the embodiment illustrated in FIG. 4C, the user 104 indicates a desire to conclude the transaction, and in response, the mobile device 106 sends to the MBE server 102 a request to perform the transaction (message 448). In one embodiment, the MBE server 102 may optionally apply rules (block 450) that govern the allowed behavior of the user's 104 payment instruments, e.g., to that verify that the requested transaction is allowed, for example. Because the MBE server 102 can maintain sensitive information related to electronic payments, for example, the MBE server 102 is uniquely positioned to store and apply user-defined rules that control which users can and cannot engage in such transactions, which payment instruments they can or cannot use, and other restraints upon transactions including spending caps, and so on.

In the embodiment illustrated in FIG. 4C, assuming that the transaction is authorized, the MBE server 102 uses the selection information to get payment information for the user 104 (block 452). In one embodiment, the MBE server 102 queries its secure database 124 to retrieve payment information or other sensitive information to be used for the desired transaction. In the embodiment illustrated in FIG. 4C, for example, the MBE server 102 sends to the database 114 a request (arrow 454) that includes information which can be used to query the database 124.

In one embodiment, the request can include information that may be used to identify a particular credit card, debit card, or other payment instrument, herein referred to as “a card pointer”. In one embodiment, the card pointer may be a number that operates as an index, key, or pointer into a database or array, etc. Alternatively, the card pointer may be a descriptive string, such as “AmEx” or “Visa1” or “Dad's Credit Card”, or even a random string of characters. The use of a pointer with no inherent payment information to query the database 124 provides an additional layer of protection against “man in the middle” attacks between a POS terminal/ecommerce website and the MBE server 102: an unauthorized viewer might see that the user 104 wants to use a MasterCard credit card, but does not see any information from which the actual account information could be reconstructed. The database 124 responds to this request by providing the transaction information (message 456). If the transaction is a payment, for example, the transaction information may include payment information. Non-payment transactions are also contemplated.

In another embodiment, the MBE server 102 may issue a request for a token, which the database 124 provides. A token is typically used to represent a payment transaction, but tokens may also be used to represent non-payment transactions as well. In one embodiment, the MBE server 102 or the database 124 may communicate with the RBE system 116 to request that a token be generated or to communicate information related to the token generation or use, or for some other purpose (message 458).

In the embodiment illustrated in FIG. 4C, the MBE server 102 sends the transaction information to the RBE system 116 (message 460). In one embodiment, the MBE server 102 may send other information. For example, the MBE server 102 may send some L/R/P data to the RBE system 116, so that the RBE system 116 will know which loyalty card was used, what rewards activity will occur (e.g., whether points were purchased or redeemed), and which promotions were taken advantage of by the user 104. This allows the RBE system 116 to track user purchases, purchase history, purchase habits, and preferences, which may be used to tailor advertisements and promotions to each particular user.

In the embodiment illustrated in FIG. 4C, the RBE system 116 processes the transaction (block 462). For a payment transaction, this may involve initiating payment, such as interaction with a payment network, bank, or other financial entity. Non-payment transactions, including, but not limited to, updating L/R/P information for a particular user, are also contemplated.

In the embodiment illustrated in FIG. 4C, the RBE system 116 may also process L/R/P data (block 464). For example, the RBE system 116 may automatically process coupons at the time of purchase, which is especially attractive for retailers who sell products for which there is a manufacturer's rebate, because the RBE system 116 can automatically issue to the manufacturer requests for reimbursement. Automatic processing of manufacturer's rebates avoids the time and expense of traditional manual methods, and reduces the number of rebates that the retailer cannot take advantage of due to data entry error or lost coupons.

In the embodiment illustrated in FIG. 4C, the result(s) of the transaction(s) may be conveyed to the user 104, directly or indirectly through the MBE server 102, the POS 112, the mobile device 106, or some combination of the above (message 466). For example, the user 104 may receive, via the mobile device 106, a text message that includes a transaction receipt.

In this manner, the system 100 provides a mechanism by which a merchant can interact with a consumer long before the last step of payment. For example, the user 104 may use the mobile device 106 to scan a QR code printed on or near an item of interest to get information about that item. The MBE server 102 can detect this interaction and provide the merchant the opportunity to determine who the user 104 is, to determine whether or not the user 104 is a loyalty or discount club member, and, if so, to notify the user 104 via the mobile device 106 or a dynamic display near the item, that there is a lower price for club members. The user 104 may be notified, via mobile device 106 or other means, that selecting one payment instrument (e.g., a credit card issued by the merchant, for example) may result in even greater discounts, rewards, points, entries into drawings or giveaways, etc. The user may be given an opportunity to redeem reward points for discounts or prizes. This information may be provided to the user 104 via the mobile device 106, via the POS terminal 112 or ecommerce site 114, or via some combination of the above. In this manner the user 104 has the opportunity to choose a discount, loyalty card, payment instrument, etc., while standing in front of the POS terminal 112, for example. The ability to engage in significant pre-payment activity allows the merchant to provide the customer with a richer, multi-dimensioned transaction experience, to the benefit of both.

Convenience.

System 100 makes possible a wide range of transactions that can be performed using mobile device 106 without the overhead of a secure connection to and from mobile device 106. In one example, a user who is shopping on an ecommerce site 114 and desires to start the checkout process to complete the purchase may select a “pay now” option displayed on the ecommerce site. In one embodiment, a QR code that includes information about the transaction (or information that may be used to retrieve information about the transaction) may be displayed on the ecommerce website checkout screen, which the user scans using mobile device 106. Mobile device 106 then may decode the QR code and send the decoded information to the MBE server 102. The MBE server 102 may then query a database to get entity-defined or user-defined preferences and rules that may determine whether the desired transaction will be allowed or not allowed, whether a notification or alert will be sent or not sent, or other specific behaviors and capabilities for specific transactions and/or accounts as defined by the user.

If the transaction is allowed, the MBE server 102 may then query the database to retrieve the pertinent account information and use that information to perform or initiate the desired transaction. Examples of an account of the user include, but are not limited to, a card payment account or a non-card, cardless, or virtual card account, a payment account; a credit, debit, or prepaid account; a branded account; a retailer or private label account; a gift or gift card account, a loyalty account; a healthcare or wellness account; an access account; a membership account; or a rewards account.

In another example, a user may desire to use mobile device 106 to perform or complete a secure financial transaction at a physical store, in which case point of interaction may be POS terminal 112. In this scenario, POS terminal 112 may transmit information over insecure channel 110 to mobile device 106, which communicates a preference for a payment type to the MBE server 102 over another insecure channel 110. The MBE server 102 provides the sensitive information needed to perform the financial transaction to POS terminal 112 over a secure backend channel 108.

Mobile device 106 may be used to provide secure authentication of the user/account owner, such as via the use of passwords, passcodes, personal identification numbers (PINs), biometrics, social networking, physical location, etc. In this scenario, authentication information (or proof of successful authentication) may be conveyed to the MBE server 102, which may then allow the desired electronic transaction.

Where the desired transaction is a financial transaction, in one embodiment, the MBE server 102 may determine, based on the application of the user-defined rules, that the transaction is allowed. In this scenario, the MBE server 102 may then retrieve confidential information, such as payment details, from a database, from secure datastore 118, or from some other datastore, and send that information to a payment transaction network that handles the transfer of funds from the user's account in one bank to the merchant's account in another bank, for example.

Examples of the information associated with the desired transaction include, but are not limited to, information about a type of the transaction, an amount of the transaction, a party to the transaction, a time of the transaction, a location of the transaction, and a good, service, or subject of the transaction.

In one embodiment, the mobile backend server receives the information associated with a desired transaction from a mobile device of the user.

In one embodiment, the mobile device of the user may receive the information associated with the desired transaction from a user of the mobile device, a point of sale terminal, an ecommerce website, or the mobile backend server.

In one embodiment, the mobile device of the user receives the information associated with the desired transaction via scanning and decoding QR code that encodes at least some of the information.

In one embodiment, the mobile device of the user receives the information associated with the desired transaction via near field communications (NFC).

Examples of transactions include, but are not limited to, transactions made using a physical point of sale terminal, transactions made online or via an ecommerce website, and transactions made using a mobile device or mobile application.

In one embodiment, the entity-defined or user-defined preferences that control behaviors and capabilities of the entity's accounts and/or account transactions on a per-user basis may include a preference related to an account.

Examples of a preference related to an account include, but are not limited to: an active/enabled or inactive/disabled state the account; a restriction on use of the account involving a user or class of users; a restriction on use of the account involving a merchant or class of merchants; a restriction on a transaction involving an ecommerce site or class of ecommerce sites; a restriction on a transaction involving a point of sale terminal or class of point of sale terminals; a restriction on use of the account for a good or class of goods; a restriction on use of the account for a service or class of services; a temporal restriction on use of the account; a geographical restriction on use of the account; a restriction on a class of accounts; a restriction on an amount or range of amounts allowed per transaction; a restriction on an amount or range of amounts allowed per a period of time; a restriction on a type of device used to perform the transaction; an ability to transfer funds to or from the account; an ability to transfer control of the account; an ability to create a sub-account; an ability of the account to be shared by multiple users; and any combination of the above.

In one embodiment, the entity-defined or user-defined preferences that control behaviors and capabilities of the entity's accounts and/or account transactions on a per-user basis may include a preference related to a transaction.

Examples of a preference related to a transaction include, but are not limited to: a restriction on a type of transaction; a restriction on a transaction involving a user or class of users; a restriction on a transaction involving a merchant or class of merchants; a restriction on a transaction involving an ecommerce site or class of ecommerce sites; a restriction on a transaction involving a point of sale terminal or class of point of sale terminals; a restriction on a transaction for a good or class of goods; a restriction on a transaction for a service or class of services; a temporal restriction on transactions; a geographical restriction on transactions; a restriction on a transaction for an amount limit or range of amounts; a restriction on a type of device used to perform the transaction; a restriction on a transaction's recurrence; and any combination of the above.

In one embodiment, the entity-defined or user-defined preferences that control behaviors and capabilities of the entity's accounts and/or account transactions on a per-user basis may include an application of a entity-defined or user-defined preference.

Examples of application of a entity-defined or user-defined preference include, but are not limited to: imposition of a user's favored preference, prohibition of a user's disfavored preference, selection of a user's most favored preference of those available for a particular transaction, and selection of a user's most favored preference of those available for a particular account.

Examples of a entity-defined or user-defined preference include, but are not limited to, a shipping preference, a level or type of authentication to be required for the transaction or account, a level of type authorization to be required for the transaction or account, and a level of type notification of the occurrence of a transaction or account.

In one embodiment, the entity-defined or user-defined preferences that control behaviors and capabilities of the entity's accounts and/or account transactions on a per-user basis may include a preference related to a condition.

Examples of a preference related to a condition include, but are not limited to, a preference related to a condition of the transaction, a preference related to a condition of the account, a preference related to a condition of the user, or any combination of the above.

In one embodiment, a user or other entity with administrative privileges can control behaviors and capabilities of the entity's accounts or account transactions as applied to another user.

Examples of the transaction or account information include, but are not limited to, an account name, an account number, an account issuing bank, a user name, a user physical address, a user shipping address, identification information for identifying a user, and authentication information for authenticating a user.

Examples of a transaction of the user include, but are not limited to, a payment or purchase, a credit transaction, a debit transaction, a deposit, a withdrawal, a money transfer, a transaction involving a loyalty program, a transaction involving a rewards program, and a transaction involving a diet, health, or fitness program.

Examples of an account of the user include, but are not limited to, a card payment account, and a non-card, cardless, or virtual card account.

Examples of an account of the user include, but are not limited to, a payment account, a credit, debit, or prepaid account, a branded account, a retailer or private label account, or a gift or gift card account.

Examples of an account of the user include, but are not limited to, a loyalty account, a healthcare or wellness account, an access account, a membership account, or a rewards account.

In one embodiment, applying user-defined preferences to the user's transactions includes receiving information associated with a desired transaction, determining a user associated with the desired transaction, determining a user account associated with the user, determining a user-defined preference for the desired transaction, for the user account, or both, and applying the user-defined preference to modify a behavior or capability of the desired transaction, user account, or both.

Examples of the information associated with the desired transaction include, but are not limited to, a type of the transaction, an amount of the transaction, a party to the transaction, a time of the transaction, a location of the transaction, and a good, service, or subject of the transaction.

In one embodiment, the mobile backend server receives the information associated with a desired transaction from a mobile device of the user. The mobile device of the user may have received the information associated with the desired transaction from a user of the mobile device, a point of sale terminal, an ecommerce website, or the mobile backend server.

In one embodiment, the mobile device of the user receives the information associated with the desired transaction via scanning and decoding QR code that encodes at least some of the information.

In one embodiment, the mobile device of the user receives the information associated with the desired transaction via near field communications (NFC).

Examples of the transactions include, but are not limited to, transactions made using a physical point of sale terminal, transactions made online or via an ecommerce website, and transactions made using a mobile device or mobile application.

In one embodiment, the entity-defined or user-defined preferences that control behaviors and capabilities of the entity's accounts and/or account transactions on a per-user basis may include a preference related to an account.

Examples of a preference related to an account include, but are not limited to: an active/enabled or inactive/disabled state the account, a restriction on use of the account involving a user or class of users, a restriction on use of the account involving a merchant or class of merchants, a restriction on a transaction involving an ecommerce site or class of ecommerce sites, a restriction on a transaction involving a point of sale terminal or class of point of sale terminals, a restriction on use of the account for a good or class of goods, a restriction on use of the account for a service or class of services, a temporal restriction on use of the account, a geographical restriction on use of the account, a restriction on a class of accounts, a restriction on an amount or range of amounts allowed per transaction, a restriction on an amount or range of amounts allowed per a period of time, a restriction on a type of device used to perform the transaction, an ability to transfer funds to or from the account, an ability to transfer control of the account, an ability to create a sub-account, an ability of the account to be shared by multiple users, and any combination of the above.

In one embodiment, the entity-defined or user-defined preferences that control behaviors and capabilities of the entity's accounts and/or account transactions on a per-user basis may include a preference related to a transaction.

Examples of a preference related to a transaction include, but are not limited to: a restriction on a type of transaction, a restriction on a transaction involving a user or class of users, a restriction on a transaction involving a merchant or class of merchants, a restriction on a transaction involving an ecommerce site or class of ecommerce sites, a restriction on a transaction involving a point of sale terminal or class of point of sale terminals, a restriction on a transaction for a good or class of goods, a restriction on a transaction for a service or class of services, a temporal restriction on transactions, a geographical restriction on transactions, a restriction on a transaction for an amount limit or range of amounts, a restriction on a type of device used to perform the transaction, a restriction on a transaction's recurrence, and any combination of the above.

In one embodiment, the entity-defined or user-defined preferences that control behaviors and capabilities of the entity's accounts and/or account transactions on a per-user basis may include an application of a entity-defined or user-defined preference.

Examples of application of an entity-defined or user-defined preference include, but are not limited to: imposition of a user's favored preference, prohibition of a user's disfavored preference, selection of a user's most favored preference of those available for a particular transaction, and selection of a user's most favored preference of those available for a particular account.

Examples of an entity-defined or user-defined preference include, but are not limited to: a shipping preference, a level or type of authentication to be required for the transaction or account, a level of type authorization to be required for the transaction or account, and a level of type notification of the occurrence of a transaction or account.

In one embodiment, the entity-defined or user-defined preferences that control behaviors and capabilities of the entity's accounts and/or account transactions on a per-user basis may include a preference related to a condition.

Examples of a preference related to a condition include, but are not limited to, a preference related to a condition of the transaction, a preference related to a condition of the account, a preference related to a condition of the user, or any combination of the above.

Advantages.

The methods and systems described herein provide a number of distinct advantages over conventional systems. By digitally connecting the shopper application to the POS terminal or ecommerce site during the checkout but before making the payment, a retailer is able to establish personalized interaction with the shopper during the checkout process. The methods and systems described herein deliver a seamless checkout experience with integrated loyalty, rewards, and promotions. Both the consumer and the retailer benefit from the rich set of incentives that are made possible by the methods and systems described above, including instant issuance of charge card payment at checkout.

The methods and systems described herein enable on-the-spot transactions anywhere—no POS terminal or cash register is needed. By transmitting information about products and services to the consumer's mobile device (via QR codes, for example) customers will be able to make instant purchases and pay from anywhere in the store. The same underlying mechanism can be applied to any kind of transaction—including in-store, in-aisle, self-checkout, online, in-app, conventional POS checkout, and home delivery—to deliver a consistent payment experience across all sales channels.

The methods and systems described herein allow customers to individually configure a retailer's charge card as a family card to be used instantly by another family member with defined purchasing limitations. The user can flexibly manage all payment types, including: loyalty and marketing; retailer charge cards, prepaid gift cards, and ACH transactions; branded debit cards, prepaid/gift, and credit cards; and integrated loyalty, rewards, coupons, deals, and promotions; all personalized and in real-time.

The cloud-based mobile payment platform using HCE and tokenization means that: there is no longer a requirement that the mobile device include a secure element; card credentials don't touch the mobile device, the POS, or the ecommerce site; the token may be changed for every transaction, for both cards and ACH transactions; and the system is scalable to a wide variety of mobile devices. The cloud-based mobile platform supports multi-factor user authentication, including, but not limited to, authentication based on the user, the device, an address, the card issuer, a driver's license (e.g., with selfie photo), a passcode, fingerprint recognition, facial recognition, voice print recognition, and other biometric information. The cloud-based mobile platform can deliver a cardholder present (CHP) payment transaction based on multi-factor user authentication through the user's mobile device, which is a lower risk transaction than a card not present (CNP) transaction, allowing for a lower transaction fee. The technology described herein can be integrated into existing merchant mobile apps and can take advantage of a merchant's existing authentication scheme. For at least all of the reasons just stated, the methods and systems described herein can prevent or drastically lower the possibility of counterfeiting, skimming, card stolen, and/or card loss transaction fraud.

The example embodiments described herein are intended to be illustrative and not limiting. It is important to note that the order of the actions and messages described above are for illustration only and are not intended to be limiting. Furthermore, embodiments having additional steps or fewer steps are also within the scope of the subject matter described herein. Entities shown in block diagrams may be a single physical entity or multiple physical entities, which may be co-located or geographically diverse. The division of labor between certain entities is also illustrative and not limiting; functions attributed to one or more entity may be performed by another entity or entities instead. Those skilled in the art will recognize improvements and modifications to the preferred embodiments of the present disclosure. All such improvements and modifications are considered within the scope of the concepts disclosed herein and the claims that follow.

1. A system for performing secure mobile payment and non-payment transactions with integrated loyalty, rewards, and promotions, the system comprising:
a mobile backend server that:
stores and maintains payment and non-payment account information for a user;
receives, from a mobile device of the user, first information associated with a first physical location proximate to a physical location of the user, and uses the first information to establish a digital communication with a merchant backend system associated with the first physical location;
presents a list of available payment and non-payment instruments to the user via the mobile device of the user prior to the user's interaction with the merchant backend system via the digital communication for shopping, item selection, or checkout; and
detects that an item is selected or scanned, and, in response to that detection:
determines incentives that are available to the user, wherein the incentives comprise loyalty points, rewards, discounts, coupons, and/or promotions;
presents the available incentives to the user for selection prior to completion of a payment or non-payment transaction with the merchant; and
determines which of the available incentives are selected by the user;
wherein the incentives and/or transaction amounts presented to the user are dynamically updated whenever a new item is selected or scanned.

2. The system of claim 1 wherein, prior to the user's interaction with a merchant for shopping, item selection, or checkout, the mobile backend server also presents available incentives known at that time.

3. The system of claim 1 wherein the mobile backend server uses information supplied by the merchant to determine incentives that are available to the user.

4. The system of claim 3 wherein the information supplied by the merchant is tailored to the particular user.

5. The system of claim 1 wherein the mobile backend server determines which of the available incentives are selected by the user by detecting active selection of an incentive by the user and/or determining that an incentive has been selected by default according to a user preference.

6. The system of claim 1 wherein the incentives presented to the user are dynamically updated during shopping or checkout prior to completion of the transaction.

7. (canceled)

8. The system of claim 1 wherein the backend server provides a side-by-side comparison of the loyalty, rewards, promotions, and/or transaction amounts for each of a plurality of different payment instruments.

9. The system of claim 1 wherein the list of available payment and non-payment instruments includes a payment or non-payment instrument that the user does not yet possess or has not yet activated or registered, wherein the mobile backend server receives from the user a request to apply for, activate, or register payment or non-payment instrument that the user does not yet possess or has not yet activated or registered, and in response to that request, applies for, activates, or registers the payment or non-payment instrument on behalf of the user.

10. (canceled)

11. (canceled)

12. The system of claim 9 wherein upon a successful result of the request, the mobile backend server updates the payment or non-payment instruments, incentives and/or transaction amounts presented to the user.

13. The system of claim 1 wherein detecting that an item is selected or scanned includes:
getting information about an item;
adding an item to a physical or virtual shopping cart; and
scanning or processing an item during a checkout process.

14. (canceled)

15. (canceled)

16. The system of claim 1 wherein transaction amounts include a total amount, a subtotal amount, a discount amount, a loyalty or rewards points amount earned or redeemed, and/or an amount of savings.

17. The system of claim 1 where transaction amounts are absolute values, relative values, and/or percentages.

18. The system of claim 1 wherein the mobile backend server analyzes the incentives that are available to the user, determines the combination of available incentives that provides the best benefit to the user, and selects the combination for the user or identifies the combination to the user.

19. The system of claim 1 wherein the mobile backend server determines that the user desires to complete the payment or non-payment transaction with the merchant, and, in response to that determination:
determines an identity of the merchant;
determines an identity of the user;
determines information that identifies the particular payment or non-payment transaction between the user and the merchant;
provides information about the user's incentives and/or payment instrument selection for use to perform the payment or non-payment transaction;
displays to the user a dashboard showing optimized discounts;
displays to the user a dashboard showing transaction amounts for the incentives and payment instruments currently selected;
redeems loyalty points and applies the redeemed amount to the transaction total;
redeems rewards, promotions, and/or item-specific coupons, and applies the redeemed amount to the transaction total; and/or
requests user confirmation of the transaction.

20. The system of claim 19 wherein the mobile backend server determines the identity of the merchant and the point of interaction of the transaction using information that is supplied by the mobile device.

21. The system of claim 20 wherein the information that is supplied by the mobile device was encoded in a QR code that was scanned and decoded by the mobile device.

22. The system of claim 21 where the information that is supplied by the mobile device was communicated to the mobile device using near field communication, Bluetooth, Wi-Fi, numeric code, barcode, and/or audio code.

23. The system of claim 19 wherein the information that identifies the particular payment or non-payment transaction between the user and the merchant comprises at least one of:
information that identifies a point of sale (POS) terminal, its location, and/or session ID;
information that identifies an ecommerce or mobile commerce session;
information that identifies a mobile device or computer of the user; and
information that identifies an authentication of the user.

24. The system of claim 19 wherein the information about the user's incentives and/or payment instrument selection is provided to a retailer backend server.

25. The system of claim 24 wherein the retailer backend server automatically processes, on behalf of the merchant, product-specific and non-product-specific coupons that were part of the transaction.

26-30. (canceled)
